(19) United States
(12) Patent Application Publication
(10) Pub. No.: US 2016/0167997 A1
(43) Pub. Date: Jun. 16, 2016

(54) METHOD FOR TREATING COOLING WATER SYSTEM

(71) Applicant: KURITA WATER INDUSTRIES LTD., Tokyo (JP)

(72) Inventors: Ikuko CHIBA, Utsunomiya-shi, Tochigi (JP); Naohiro NAGAI, Saitama-shi, Saitama (JP); Takanori YOSHINO, Kuki-shi, Saitama (JP); Masato NAKANO, Kakogawa-shi, Hyogo (JP); Yuki SANO, Sakai-shi, Osaka (JP)

(21) Appl. No.: 14/906,769

(22) PCT Filed: Jul. 24, 2014
(86) PCT No.: PCT/JP2014/069594

§ 371 Date: Jan. 21, 2016

(30) Foreign Application Priority Data
Jul. 25, 2013 (JP) 2013-154691

(51) Int. Cl. C02F 5/10; C23F 11/173

(52) U.S. Cl. CPC C02F 5/10; C23F 11/173; C02F 2303/08; C02F 2103/023

(57) ABSTRACT

A method for treating a cooling water system includes adding a (meth)acrylic acid-based copolymer to a cooling water system having a part where the calcium hardness of the cooling water is 150 to 300 mg/L and the flow rate of the cooling water is 0.3 to 0.5 m/s, wherein the (meth)acrylic acid-based copolymer has a structural unit (a) derived from a specific (meth)acrylic acid-based monomer (A) and a structural unit (b) derived from a specific (meth)allyl ether-based monomer (B), the content of the structural unit (b) is 15% by mole to 20% by mole relative to 100% by mole of the structural units derived from all the monomers, the weight-average molecular weight of the (meth)acrylic acid-based copolymer is 10,000 to 30,000, and at least one of the main chain terminal groups of the (meth)acrylic acid-based copolymer is a sulfonic acid group or a salt thereof.

### TECHNICAL FIELD

The present invention relates to a method for treating a cooling water system and specifically relates to a method for treating a cooling water system by which the metal corrosion of a heat exchanger and the like in a cooling water system with a low flow rate is prevented.

### BACKGROUND ART

Metal members installed in a cooling water system such as an open circulating cooling water system, for example metal members of carbon steel, copper, a copper alloy or the like constituting a pipe, a heat exchanger or the like, are corroded when the metal members touch the cooling water. Thus, anticorrosion treatment of a cooling water system is generally conducted by adding a chemical agent.

For example, in order to inhibit the corrosion of carbon steel, a phosphorous compound such as an orthophosphoric acid salt, a hexametaphosphoric acid salt, a hydroxyethylidene phosphonic acid salt and a phosphonobutane tricarboxylic acid salt is added to cooling water. Also, a heavy metal salt such as a zinc salt and a bichromate is sometimes added alone or in combination.

It has been found that, even when the same circulating water is used, a metal member is corroded easier as the flow rate in the cooling water system becomes lower. In particular, when the flow rate is 0.5 m/s or less, a metal member is apt to be corroded considerably (NPL 1). Therefore, in a cooling water system with a low flow rate, an anticorrosion agent such as phosphoric acid or zinc and a polymer for dispersing the anticorrosion agent must be added at high concentrations, and the environmental burden is high.

Accordingly, a method for treating a cooling water system by which the corrosion in a cooling water system with a low flow rate is prevented by the addition of a small amount of an anticorrosion agent is desired.

PTL 1 reports a method in which the amount of an anticorrosion agent added and the calcium hardness of water are controlled depending on the flow rate. According to the method, however, it is necessary to increase the amount of the anticorrosion agent or to increase the calcium hardness of water to prevent the corrosion in a cooling water system with a low flow rate. Thus, the method of PTL 1 is not a method by which the corrosion in a cooling water system with a low flow rate is prevented by the addition of a small amount of an anticorrosion agent.

PTLs 2 and 3 disclose a (meth)acrylic acid-based polymer having a sulfonic acid group at a main chain terminal as a polymer which exhibits a good effect of preventing scale and an anticorrosion effect in a water system in which the calcium hardness is high and describe that the polymer improves the gelation resistance and exerts an excellent anticorrosion effect also in a water system with a high calcium concentration. However, PTLs 2 and 3 do not disclose the anticorrosion effect in a water system in which the calcium hardness is low and the tendency toward corrosion is strong. Also, PTLs 2 and 3 do not disclose the anticorrosion effect in a water system in which the flow rate is low and the tendency toward corrosion is strong.

### CITATION LIST

### Patent Literature

PTL 1: JP-A-3-236485

PTL 2: JP-A-2002-003536

PTL 3: JP-A-2005-264190

### Non Patent Literature

NPL 1: Kurita Water Industries, Yakuhinn Hanndobukku, 4th edition, edited by Kurita Water Industries Ltd., Yakuhinn Hanndobukku editorial committee

### SUMMARY OF INVENTION

### Technical Problem

In view of the circumstances, an object of the present invention is to provide a method for treating a cooling water system by which the corrosion of a metal member of a heat exchanger, a pipe or the like in a cooling water system using water with low calcium hardness and a low flow rate is prevented without adding a chemical agent with a high concentration.

### Solution to Problem

In order to achieve the object, the present inventors made extensive and intensive investigations. As a result, the present inventors have found that the object can be achieved by adding a (meth)acrylic acid-based copolymer which contains a structural unit (a) derived from a specific (meth)acrylic acid-based monomer and a structural unit (b) derived from a specific (meth)allyl ether-based monomer in a specific amount, which has a specific weight-average molecular weight, and in which at least one of the main chain terminal groups is a sulfonic acid group or a salt thereof to a cooling water system with low calcium hardness and a low flow rate. The present inventors have thus accomplished the present invention.

Specifically, the present invention is at least as follows.

[1] A method for treating a cooling water system, which includes adding a (meth)acrylic acid-based copolymer to a cooling water system having a part where the calcium hardness of cooling water is 150 to 300 mg/L and the flow rate of the cooling water is 0.3 to 0.5 m/s,

wherein the (meth)acrylic acid-based copolymer has a structural unit (a) derived from a (meth)acrylic acid-based monomer (A) represented by the following general formula (1) and a structural unit (b) derived from a (meth)allyl ether-based monomer (B) represented by the following general formula (2),

the content of the structural unit (b) is 15% by mole to 20% by mole relative to 100% by mole of the structural units derived from all the monomers,

the weight-average molecular weight of the (meth)acrylic acid-based copolymer is 10,000 to 30,000, and

at least one of the main chain terminal groups of the (meth)acrylic acid-based copolymer is a sulfonic acid group or a salt thereof:

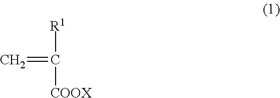

wherein R¹ represents a hydrogen atom or a methyl group, and X represents a hydrogen atom, a metal atom, an ammonium group or an organic amine;

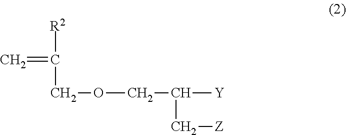

wherein R² represents a hydrogen atom or a methyl group, Y and Z each independently represent a hydroxyl group, a sulfonic acid group or a salt thereof, and at least one of Y and Z represents a sulfonic acid group or a salt thereof.

[2] The method for treating a cooling water system as set forth above in [1], wherein the (meth)acrylic acid-based copolymer comprises a structural unit (a) derived from one, two or more (meth)acrylic acid-based monomers (A) selected from acrylic acid, methacrylic acid and sodium acrylate and a structural unit (b) derived from sodium 3-(meth)allyloxy-2-hydroxy-1-propanesulfonate.

[3] The method for treating a cooling water system as set forth above in [1] or [2], wherein the treatment agent is added to the cooling water system in a manner that the concentration of the (meth)acrylic acid-based copolymer in the cooling water becomes 0.01 to 25 mg/L.

[4] The method for treating a cooling water system as set forth above in any one of [1] to [3], wherein the (meth)acrylic acid-based copolymer is added when the concentration of the copolymer in the cooling water is lower than 0.01 mg/L, and the addition of the (meth)acrylic acid-based copolymer is stopped when the concentration of the copolymer in the cooling water is higher than 25 mg/L.

[5] The method for treating a cooling water system as set forth above in any one of [1] to [4], wherein the (meth)acrylic acid-based copolymer is added to the part where the calcium hardness of the cooling water is 150 to 300 mg/L and the flow rate of the cooling water is 0.3 to 0.5 m/s or to an upstream part thereof.

### Advantageous Effects of Invention

In accordance with the present invention, it is possible to provide a method for treating a cooling water system by which the corrosion of a metal member of a heat exchanger, a pipe or the like in a cooling water system using water with low calcium hardness and a low flow rate is prevented without adding a chemical agent with a high concentration.

### DESCRIPTION OF EMBODIMENTS

The method for treating a cooling water system of the present invention is a method for treating a cooling water system, which includes adding a (meth)acrylic acid-based copolymer to a cooling water system having a part where the calcium hardness of cooling water is 150 to 300 mg/L and the flow rate of the cooling water is 0.3 to 0.5 m/s,

wherein the (meth)acrylic acid-based copolymer has a structural unit (a) derived from a (meth)acrylic acid-based monomer (A) represented by the following general formula (1) and a structural unit (b) derived from a (meth)allyl ether-based monomer (B) represented by the following general formula (2), the content of the structural unit (b) is 15% by mole to 20% by mole relative to 100% by mole of the structural units derived from all the monomers, the weight-average molecular weight of the (meth)acrylic acid-based copolymer is 10,000 to 30,000, and at least one of the main chain terminal groups of the (meth)acrylic acid-based copolymer is a sulfonic acid group or a salt thereof

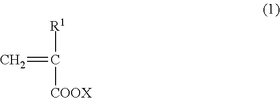

wherein R¹ represents a hydrogen atom or a methyl group, and X represents a hydrogen atom, a metal atom, an ammonium group or an organic amine;

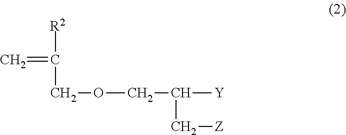

wherein R² represents a hydrogen atom or a methyl group, Y and Z each independently represent a hydroxyl group, a sulfonic acid group or a salt thereof, and at least one of Y and Z represents a sulfonic acid group or a salt thereof.

### [(Meth)Acrylic Acid-Based Copolymer]

The (meth)acrylic acid-based copolymer used in the method for treating a cooling water system of the present invention is a copolymer which contains a structural unit (a) derived from a (meth)acrylic acid-based monomer (A) represented by the general formula (1) and a structural unit (b) derived from a (meth)allyl ether-based monomer (B) represented by the general formula (2) and in which at least one of the main chain terminal groups is a sulfonic acid group or a salt thereof.

Specifically, the structural unit (a) and the structural unit (b) are the structural units represented by the following general formulae (3) and (4), respectively.

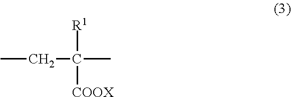

wherein R¹ and X are the same as those in the general formula (1).

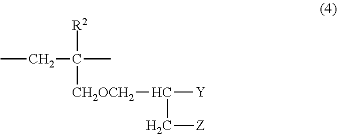

wherein R², Y and Z are the same as those in the general formula (2).

### ((Meth)Acrylic Acid-Based Monomer (A))

The (meth)acrylic acid-based monomer (A) is represented by the general formula (1). With respect to X in the general formula (1), specific examples of the metal atom include lithium, sodium, potassium and the like, and specific examples of the organic amine include monoethanolamine, diethanolamine, triethanolamine and the like.

Specific examples of the (meth)acrylic acid-based monomer (A) include acrylic acid, methacrylic acid and salts thereof (for example, sodium salts, potassium salts, ammonium salts and the like). Of these examples, acrylic acid, sodium acrylate and methacrylic acid are preferred, and acrylic acid (AA) is more preferred. A kind thereof may be used alone, or a combination of two or more kinds thereof may be used.

The term “(meth)acrylic acid-based” refers to both acrylic acid-based and methacrylic acid-based. The same applies to other similar terms.

### ((Meth)Allyl Ether-Based Monomer (B))

The (meth)allyl ether-based monomer (B) is represented by the general formula (2). Regarding the sulfonic acid group or the salt thereof represented by Y and Z in the general formula (2), specific examples of the metal salt include salts with sodium, potassium, lithium and the like, and specific examples of the salt of sulfonic acid and an organic amine include salts with monoethanolamine, diethanolamine, triethanolamine and the like.

Specific examples of the (meth)allyl ether-based monomer (B) include 3-(meth)allyloxy-2-hydroxy-1-propanesulfonic acid and salts thereof and 3-(meth)allyloxy-1-hydroxy-2-propanesulfonic acid and salts thereof. Of these examples, sodium 3-(meth)allyloxy-2-hydroxy-1-propanesulfonate is preferred, and sodium 3-allyloxy-2-hydroxy-1-propanesulfonate (HAPS) is more preferred. A kind thereof may be used alone, or a combination of two or more kinds thereof may be used.

The term “(meth)allyl ether-based” refers to both allyl ether-based and methallyl ether-based. The same applies to other similar terms.

### <Mole Ratio>

The (meth)acrylic acid-based copolymer is a copolymer containing the structural unit (a) derived from the (meth)acrylic acid-based monomer (A) and the structural unit (b) derived from the (meth)allyl ether-based monomer (B), and the content of the structural unit (b) is 15 to 20% by mole relative to 100% by mole of the structural units derived from all the monomers. When the content of the structural unit (b) is less than 15% by mole or more than 20% by mole, the ability of forming an anticorrosion film derived from the anticorrosive component such as phosphorus and zinc diminishes, and the anticorrosive performance is thus impaired. From the viewpoint, the content of the structural unit (b) relative to 100% by mole of the structural units derived from all the monomers is preferably 16 to 20% by mole, and more preferably 16 to 19% by mole.

From the same viewpoint, the content of the structural unit (b) relative to total 100% by mole of the structural unit (a) and the structural unit (b) is preferably 15 to 20% by mole, more preferably 16 to 20% by mole, and still more preferably 16 to 19% by mole.

From the viewpoint of the anticorrosive performance, the content of the structural unit (a) relative to 100% by mole of the structural units derived from all the monomers is preferably 80 to 85% by mole, more preferably 80 to 84% by mole, and still more preferably 81 to 84% by mole.

### <Weight-Average Molecular Weight>

The weight-average molecular weight of the (meth)acrylic acid-based copolymer is 10,000 to 30,000. When the weight-average molecular weight is less than 10,000, the anticorrosive performance is impaired. When the weight-average molecular weight is more than 30,000, the gelation is apt to occur, and the polymer is apt to be consumed. From the viewpoints, the weight-average molecular weight is preferably 10,000 to 29,000.

The weight-average molecular weight is a standard polyacrylic acid-equivalent value obtained by the gel permeation chromatography method (GPC method).

### (Another Monomer (C))

The (meth)acrylic acid-based copolymer should have at least the structural unit (b) in the proportion of 15 to 20% by mole relative to 100% by mole of the structural units derived from all the monomers but preferably has the structural unit (a) in the above proportion. In addition to the structural units, a structural unit (c) derived from another monomer (C) which can be copolymerized with the (meth)acrylic acid-based monomer (A) or the (meth)allyl ether-based monomer (B) may be contained. In this case, the proportion of the structural unit (c) relative to 100% by mole of the structural units derived from all the monomers is preferably 10% by mole or less, and more preferably 5% by mole or less.

As the other monomer (C), for example, sulfonic acid group-containing unsaturated monomers such as 2-(meth)acrylamide-2-methylpropanesulfonic acid, (meth)allylsulfonic acid, vinylsulfonic acid, styrenesulfonic acid and 2-sulfoethylmethacrylate, and salts thereof, N-vinyl monomers such as N-vinylpyrrolidone, N-vinylformamide, N-vinylacetamide, N-vinyl-N-methylformamide, N-vinyl-methylacetamide and N-vinyloxazolidone; nitrogen-containing nonionic unsaturated monomers such as (meth)acrylamide, N, N-dimethylacrylamide and N-isopropylacrylamide; hydroxyl group-containing unsaturated monomers such as 3-(meth)allyloxy-1,2-dihydroxypropane, (meth)allyl alcohol and isoprenol; polyoxyethylene group-containing unsaturated monomers such as a compound obtained by adding about 1 to 200 moles of ethylene oxide to 3-(meth)allyloxy-1,2-dihydroxypropane (3-(meth)allyloxy-1,2-di(poly)oxyethylene ether propane) and a compound obtained by adding about 1 to 100 moles of ethylene oxide to (meth)allyl alcohol; (meth)acrylic acid esters such as methyl (meth)acrylate, ethyl (meth)acrylate, butyl (meth)acrylate and hydroxyethyl (meth)acrylate; unsaturated dicarboxylic acid monomers such as itaconic acid; aromatic unsaturated monomers such as styrene; and the like are included.

A kind of the monomer (C) may be used alone, or a combination of two or more kinds may be used.

### (Production Method)

As a method for producing the (meth)acrylic acid-based copolymer, a method in which a monomer mixture containing the monomers (A) and (B) and the monomer (C) used according to need (hereinafter also simply referred to as a “monomer mixture”) is polymerized in the presence of a polymerization initiator is included.

### <Polymerization Initiator>

As the polymerization initiator, known polymerization initiators can be used. For example, hydrogen peroxide; persulfates such as sodium persulfate, potassium persulfate and ammonium persulfate; azo compounds such as dimethyl 2,2′-azobis(2-methylpropionate), 2,2′-azobis(isobutyronitrile), 2,2′-azobis(2-methylbutyronitrile), 2,2′-azobis(2,4-dimethylvaleronitrile), 2,2′-azobis(4-methoxy-2,4-dimethylvaleronitrile), dimethyl 2,2′-azobis(isobutyrate), 4,4′-azobis(4-cyanovaleric acid), 2,2′-azobis(2-methylpropionamidine)dihydrochloride, 2,2′-azobis[N-(2-carboxyethyl)-2-methylpropionamidine]n-hydrate, 2,2′-azobis[2-(2-imidazolin-2-yl)propane]dihydrochloride, 2,2′-azobis[2-(2-imidazolin-2-yl)propane]disulfate dihydrate and 1,1′-azobis(cyclohexane-1-carbonitrile); organic peroxides such as benzoyl peroxide, lauroyl peroxide, peracetic acid, di-t-butyl peroxide and cumene hydroperoxide; and the like are preferred. Of these polymerization initiators, from the viewpoint of improvement of the gelation resistance of the obtained polymer, the persulfates described below are preferably used.

The amount of the polymerization initiator to be used is not particularly limited as long as the copolymerization of the monomer mixture can be initiated, but desirably, the amount is preferably 15 g or less, and more preferably 1 to 12 g, per mole of the monomer mixture, except for the cases which will be particularly described below.

### <Chain Transfer Agent>

In the method for producing the (meth)acrylic acid-based copolymer, a chain transfer agent may be used as a molecular weight modifier of the polymer according to need within the range where the polymerization is not adversely affected.

As the chain transfer agent, specifically, thiol chain transfer agents such as mercaptoethanol, thioglycerol, thioglycolic acid, 2-mercaptopropionic acid, 3-mercaptopropionic acid, thiomalic acid, octyl thioglycolate, octyl 3-mercaptopropionate, 2-mercaptoethanesulfonic acid, n-dodecyl mercaptan, octyl mercaptan and butyl thioglycolate; halides such as carbon tetrachloride, methylene chloride, bromoform and bromotrichloroethane; secondary alcohols such as isopropanol and glycerin; lower oxides and salts thereof such as phosphorous acid, hypophosphorous acid and salts thereof (sodium hypophosphite, potassium hypophosphite and the like), sulfurous acid, bisulfurous acid, dithionous acid, metabisulfurous acid and salts thereof (hereinafter also referred to as “a bisulfurous acid (bisulfite)”, for example, sodium bisulfite, potassium bisulfite, sodium dithionite, potassium dithionite, sodium metabisulfite, potassium metabisulfite and the like); and the like are included. A kind of the chain transfer agents may be used alone, or a combination of two or more kinds may be used.

When the chain transfer agents are used, it is possible to inhibit the molecular weight of the produced copolymer from becoming higher than is necessary and to produce a copolymer having a low molecular weight efficiently. Of the chain transfer agents, it is preferred to use a bisulfurous acid (bisulfite) in the copolymerization reaction according to the present invention. By the use, a sulfonic acid group can be introduced efficiently to a main chain terminal of the copolymer to be obtained, and the gelation resistance can be improved. Also, it is preferred to use a bisulfurous acid (bisulfite) as the chain transfer agent because the color tone of the copolymer (composition) can be improved.

The amount of the chain transfer agent to be added is not limited as long as the monomer mixture is polymerized well but is preferably 1 to 20 g, and more preferably 2 to 15 g, preferably per mole of the monomer mixture, except for the cases which will be particularly described below.

### <Initiator System>

In the method for producing the (meth)acrylic acid-based copolymer, it is preferred to use a combination of one or more kinds of persulfate and one or more kinds of bisulfurous acid (bisulfite) as an initiator system (a combination of a polymerization initiator and a chain transfer agent). By the use, it is possible to introduce a sulfonic acid group efficiently to a main chain terminal of the polymer, to obtain a water-soluble polymer having a low molecular weight which has excellent gelation resistance as well as excellent dispersibility and excellent chelatability and to obtain the functional effects of the present invention effectively. By adding a bisulfurous acid (bisulfite) to the initiator system in addition to a persulfate, it is possible to inhibit the molecular weight of the obtained polymer from becoming higher than is necessary and to produce a polymer having a low molecular weight efficiently.

Specifically, as the persulfate, sodium persulfate, potassium persulfate, ammonium persulfate and the like can be included.

In the present invention, the bisulfurous acid (bisulfite) is as described above, but of the examples, sodium bisulfite, potassium bisulfite and ammonium bisulfite are preferred.

When a persulfate and a bisulfurous acid (bisulfite) are used in combination, the ratio of the bisulfurous acid (bisulfite) to one part by mass of the persulfate is in the range of preferably 0.1 to 5 parts by mass, more preferably 0.2 to 3 parts by mass, and still more preferably 0.2 to 2 parts by mass. When the amount of the bisulfurous acid (bisulfite) is less than 0.1 parts by mass per part by mass of the persulfate, the effects of the bisulfurous acid (bisulfite) tend to deteriorate. Thus, the amount of the sulfonic acid groups introduced to the terminals of the polymer decreases, and the gelation resistance of the copolymer tends to be impaired. Also, the weight-average molecular weight of the (meth)acrylic acid-based copolymer tends to be high. On the other hand, when the amount of the bisulfurous acid (bisulfite) is more than five parts by mass per part by mass of the persulfate, the system is in the state where the effects of the bisulfurous acid (bisulfite) cannot be obtained as much as expected from the ratio, and the bisulfurous acid (bisulfite) tends to be supplied excessively (wasted) to the polymerization reaction system. As a result, the excess bisulfurous acid (bisulfite) is degraded in the polymerization reaction system, and a large amount of sulfurous acid gas (SO₂ gas) is generated. Moreover, a large amount of impurities are formed in the (meth)acrylic acid-based copolymer, and the properties of the obtained (meth)acrylic copolymer tend to deteriorate. In addition, the impurities tend to precipitate easily while the copolymer is held at a low temperature.

When a persulfate and a bisulfurous acid (bisulfite) are used, the total amount of the persulfate and the bisulfurous acid (bisulfite) added per mole of the monomer mixture is preferably 2 to 20 g, more preferably 2 to 15 g, still more preferably 3 to 10 g, and yet still more preferably 4 to 9 g. When the amount of the persulfate and the bisulfurous acid (bisulfite) is less than 2 g, the molecular weight of the obtained polymer tends to increase. Also, the amount of the sulfonic acid groups introduced to the terminals of the obtained (meth)acrylic acid-based copolymer tends to decrease. On the other hand, when the amount is more than 20 g, the effects of the persulfate and the bisulfurous acid (bisulfite) cannot be obtained as much as expected from the amount, and on the contrary, the purity of the obtained (meth)acrylic acid-based copolymer tends to decrease.

The persulfate may be added in the form of a solution of the persulfate (preferably an aqueous solution) obtained by dissolving in the solvent described below, preferably in water. When the persulfate is used as the persulfate solution (preferably an aqueous solution), the concentration is preferably 1 to 35% by mass, more preferably 5 to 35% by mass, and still more preferably 10 to 30% by mass. When the concentration of the persulfate solution is less than 1% by mass, the concentration of the product decreases, and the transportation and the storage are complicated. On the other hand, when the concentration of the persulfate solution is more than 35% by mass, handling is difficult.

The bisulfurous acid (bisulfite) may be added in the form of a solution of the bisulfurous acid (bisulfite) (preferably an aqueous solution) obtained by dissolving in the solvent described below, preferably in water. When the bisulfurous acid (bisulfite) is used as the bisulfurous acid (bisulfite) solution (preferably an aqueous solution), the concentration is preferably 10 to 42% by mass, more preferably 20 to 42% by mass, and still more preferably 32 to 42% by mass. When the concentration of the bisulfurous acid (bisulfite) solution is less than 10% by mass, the concentration of the product decreases, and the transportation and the storage are complicated. On the other hand, when the concentration of the bisulfurous acid (bisulfite) solution is more than 42% by mass, handling is difficult.

### <Other Additives>

In the method for producing the (meth)acrylic acid-based copolymer, as additives, other than the initiator and the chain transfer agent, which can be used for the polymerization reaction system when the monomer mixture is polymerized in an aqueous solution, additives which are suitable within the range where the functional effects of the present invention are not affected, such as a heavy metal concentration regulator and a pH regulator, can be added in suitable amounts.

The heavy metal concentration regulator is not particularly limited, and for example, a polyvalent metal compound or a simple substance can be used. Specifically, water-soluble polyvalent metal salts such as vanadium oxytrichloride, vanadium trichloride, vanadyl oxalate, vanadyl sulfate, vanadic acid anhydride, ammonium metavanadate, ammonium hypovanadous sulfate [(NH₄)₂SO₄—VSO₄.6H₂O], ammonium vanadous sulfate [(NH₄)V(SO₄)₂.12H₂O], copper(II) acetate, copper(II), copper(II) bromide, copper(II) acetylacetate, ammonium cupric chloride, ammonium copper chloride, copper carbonate, copper(II) chloride, copper(II) citrate, copper(II) formate, copper(II) hydroxide, copper nitrate, copper naphthenate, copper(II) oleate, copper maleate, copper phosphate, copper(II) sulfate, cuprous chloride, copper(I) cyanide, copper iodide, copper(I) oxide, copper thiocyanate, iron acetylacenate, ammonium iron citrate, ferric ammonium oxalate, ammonium iron sulfate, ferric ammonium sulfate, iron citrate, iron fumarate, iron maleate, ferrous lactate, ferric nitrate, iron pentacarbonyl, ferric phosphate and ferric pyrophosphate; polyvalent metal oxides such as vanadium pentoxide, copper(II) oxide, ferrous oxide and ferric oxide; polyvalent metal sulfides such as iron(III) sulfide, iron(II) sulfide and copper sulfide; copper powder, iron powder and the like can be included.

In the method for producing the (meth)acrylic acid-based copolymer, because the heavy metal ion concentration of the obtained (meth)acrylic acid-based copolymer is preferably 0.05 to 10 ppm, a suitable amount of the heavy metal concentration regulator is desirably added according to need.

### (Polymerization Solvent)

When the (meth)acrylic acid-based copolymer is produced, in general, the monomer mixture is polymerized in a solvent. The solvent used here for the polymerization reaction system is preferably an aqueous solvent such as water, an alcohol, glycol, glycerin and polyethylene glycol, and particularly preferably water. A kind thereof may be used alone, or a combination of two or more kinds thereof may be used. Also, in order to improve the solubility of the monomer mixture in the solvent, an organic solvent may be suitably added within the range where the polymerization of the monomers is not adversely affected.

As the organic solvent, specifically, one, two or more kinds suitably selected from lower alcohols such as methanol and ethanol; amides such as dimethyl formaldehyde; ethers such as diethyl ether and dioxane; and the like can be used.

The amount of the organic solvent to be used relative to the total amount of the monomer mixture is in the range of preferably 40 to 200% by mass, more preferably 45 to 180% by mass, and still more preferably 50 to 150% by mass. When the amount of the solvent is less than 40% by mass, the molecular weight becomes high. On the other hand, when the amount of the solvent is more than 200% by mass, the concentration of the (meth)acrylic acid-based copolymer produced decreases, and removal of the solvent is sometimes necessary. In this regard, a large part or the total amount of the solvent may be supplied to the reaction container at the initial stage of polymerization. However, for example, a part of the solvent may be suitably added (dropped) alone to the reaction system during the polymerization, or a part of the solvent may be suitably added (dropped) to the reaction system during the polymerization with the monomer mixture components, the initiator component and other additives in the form of a solution obtained by dissolving the components in the solvent in advance.

### (Polymerization Temperature)

The polymerization temperature of the monomer mixture is not particularly limited. From the viewpoint of efficiently producing the polymer, the polymerization temperature is preferably 50° C. or higher, and more preferably 70° C. or higher, and the polymerization temperature is preferably 99° C. or lower, and more preferably 95° C. or lower. When the polymerization temperature is lower than 50° C., the molecular weight increases, and the amount of impurities increases. Also, since the polymerization period is too long, the productivity decreases. On the other hand, it is preferred that the polymerization temperature is adjusted to 99° C. or lower because, when a bisulfurous acid (bisulfite) is used as the initiator system, sulfurous acid gas can be inhibited from being generated in a large amount due to the decomposition of the bisulfurous acid (bisulfite). The polymerization temperature here means the temperature of the reaction solution in the reaction system.

Especially in a method of initiating the polymerization at room temperature (room temperature-initiated method), the temperature is raised in such a manner that the temperature reaches the set temperature (which should be in the above polymerization temperature range but which is around preferably 70 to 90° C., and more preferably 80 to 90° C.) within 70 minutes, preferably within 0 to 50 minutes, and more preferably within 0 to 30 minutes, for example when the polymerization is conducted for 180 minutes per batch (180-minute method). Then, the set temperature is desirably maintained until the polymerization is finished. When the heating period is not in the range, the molecular weight of the obtained (meth)acrylic acid-based copolymer may become high. Although an example where the polymerization period is 180 minutes is given here, when the conditions of the polymerization period are different, the heating period is desirably set in such a manner that the ratio of the heating period to the polymerization period becomes similar, referring to the example.

### (Pressure of Reaction System and Reaction Atmosphere)

When the monomer mixture is polymerized, the pressure in the reaction system is not particularly limited and may be any of normal pressure (atmospheric pressure), reduced pressure and increased pressure. Preferably, when a bisulfurous acid (bisulfite) is used as the initiator system, in order to prevent the emission of sulfurous acid gas and to enable the reduction in the molecular weight during the polymerization, the polymerization is conducted at normal pressure or at increased pressure in a closed reaction system. Also, when the polymerization is conducted at normal pressure (atmospheric pressure), it is not necessary to combine a pressure device or a pressure reducing device, and it is not necessary to use a pressure-resistant reaction container or a pressure-resistant pipe. Thus, from the viewpoint of production cost, normal pressure (atmospheric pressure) is preferred. That is, the optimum pressure condition can be suitably set depending on the purpose of use of the obtained (meth)acrylic acid-based copolymer.

The atmosphere in the reaction system may be air atmosphere but is preferably an inert gas atmosphere. For example, the atmosphere in the system is desirably substituted with an inert gas such as nitrogen before initiating the polymerization. This can prevent the atmosphere gas (for example, oxygen gas and the like) in the reaction system from dissolving into the liquid phase and acting as a polymerization inhibitor. As a result, the initiator (a persulfate or the like) can be prevented from being deactivated and reduced in amount, and the molecular weight can be further decreased.

### (Degree of Neutralization During Polymerization)

In the method for producing the (meth)acrylic acid-based copolymer, the polymerization reaction of the monomer mixture is desirably conducted under acidic conditions. By conducting the polymerization reaction under acidic conditions, the viscosity of the aqueous solution of the polymerization reaction system can be inhibited from increasing, and a (meth)acrylic acid-based copolymer having a low molecular weight can be produced well. Moreover, because the polymerization reaction can progress under a higher concentration condition than the conventional methods, the production efficiency can be improved greatly. In particular, by keeping the degree of neutralization during the polymerization low, namely 0 to 25% by mole, the effects achieved by the reduction of the initiator amount can be enhanced synergistically, and the effect of reducing the amount of impurities can be improved significantly. Furthermore, during the polymerization, the pH of the reaction solution at 25° C. is desirably adjusted to one to six. By conducting the polymerization reaction under such acidic conditions, the polymerization can be conducted at a high concentration and in one stage, and the concentration step can be thus skipped. Therefore, the productivity increases greatly, and the production cost can be inhibited from increasing.

With respect to the acidic conditions, the pH of the reaction solution at 25° C. during the polymerization is preferably one to six, more preferably one to five, and still more preferably one to four. When the pH is less than one, sulfurous acid gas may be generated and the apparatus may be corroded in case where a bisulfurous acid (bisulfite) is used as the initiator system for example. On the other hand, when the pH is more than six, in case where a bisulfurous acid (bisulfite) is used as the initiator system, the efficiency of the bisulfurous acid (bisulfite) decreases, and the molecular weight increases.

As the pH regulator for regulating the pH of the reaction solution, alkali metal hydroxides such as sodium hydroxide and potassium hydroxide, alkaline earth metal hydroxides such as calcium hydroxide and magnesium hydroxide, salts of organic amines such as ammonia, monoethanolamine and triethanolamine, and the like are included. A kind thereof may be used alone, or a combination of two or more kinds thereof may be used. Of these pH regulators, alkali metal hydroxides such as sodium hydroxide and potassium hydroxide are preferred, and sodium hydroxide is particularly preferred. In the present description, these pH regulators are sometimes simply referred to as “a pH regulator” or “a neutralizer”.

The degree of neutralization of the carboxylic acid during the polymerization is in the range of preferably 0 to 25% by mole, more preferably 1 to 15% by mole, and still more preferably 2 to 10% by mole. When the degree of neutralization during the polymerization is in the range, the monomers can be copolymerized most suitably. Also, the amount of impurities can be reduced, and a polymer with good gelation resistance can be produced. Furthermore, the viscosity of the aqueous solution of the polymerization reaction system does not increase, and a polymer having a low molecular weight can be produced well. In addition, because the polymerization reaction can progress under a higher concentration condition than the conventional methods, the production efficiency can be improved greatly.

On the other hand, when the degree of neutralization during the polymerization is more than 25% by mole, the chain transfer efficiency of the bisulfurous acid (bisulfite) decreases, and the molecular weight sometimes increases. In addition, the increase in the viscosity of the aqueous solution of the polymerization reaction system becomes remarkable as the polymerization progresses. As a result, the molecular weight of the obtained polymer becomes higher than is necessary, and a polymer having a low molecular weight cannot be obtained. Furthermore, the effects achieved by the reduction of the degree of neutralization cannot be obtained sufficiently, and it is sometimes difficult to reduce the amount of impurities greatly.

The neutralization method here is not particularly limited. For example, a salt of (meth)acrylic acid such as sodium (meth)acrylate may be used as a part of raw materials, or neutralization may be conducted during the polymerization using an alkali metal hydroxide such as sodium hydroxide or the like as the neutralizer. These methods may be used in combination. The neutralizer to be added for the neutralization may be in the form of solid or an aqueous solution obtained by dissolving in a suitable solvent, preferably water.

When an aqueous solution is used, the concentration of the aqueous solution is preferably 10 to 60% by mass, more preferably 20 to 55% by mass, and still more preferably 30 to 50% by mass. When the concentration of the aqueous solution is less than 10% by mass, the concentration of the product decreases, and the transportation and the storage are complicated, while when the concentration is more than 60% by mass, solution-sending is complicated because precipitation may occur and the viscosity is high.

### (Conditions for Adding Raw Materials)

It is preferred that the monomer mixture, the initiator, the chain transfer agent and the other additives are each dissolved in a suitable solvent (preferably a solvent of the same kind as the solvent for the solutions to be dropped) in advance to prepare a monomer mixture solution, an initiator solution, a chain transfer agent solution and a solution of the other additives and that the polymerization is conducted while continuously dropping the solutions over predetermined dropping periods to a (aqueous) solvent (if necessary, adjusted to a predetermined temperature) in a reaction container. Furthermore, a part of the aqueous solvent may also be dropped later separately from the initially supplied solvent which has been supplied in advance to the container of the reaction system. However, the production method should not be restricted to the method.

For example, with respect to the dropping method, the solutions may be dropped continuously or divided into some small portions and dropped intermittently. A part or the total amount of one, two or more kinds of monomer may be initially supplied. Also, the dropping rate (dropped amount) of one, two or more kinds of monomer may be always constant (constant amount) from the start of dropping to the end, or the dropping rate (dropped amount) may be changed with time depending on the polymerization temperature or the like. It is not necessary that all of the components to be dropped are dropped in the same manner, but the start or the end of dropping may be changed individually for each component to be dropped, and the dropping periods may be shortened or prolonged. When the components are dropped each in the form of a solution, the solutions to be dropped may be heated to a temperature similar to the polymerization temperature of the reaction system. When the solutions are heated in this manner, the temperature change is small, and the temperature regulation is easy in case where the polymerization temperature is kept constant.

With respect to the dropping periods of the monomers during the polymerization, the end of dropping of the monomer (B) is preferably earlier than the end of dropping of the monomer (A) by preferably 1 to 60 minutes, more preferably 10 to 50 minutes, and still more preferably 20 to 40 minutes.

When a bisulfurous acid (bisulfite) is used as the initiator system, the molecular weight at the initial stage of polymerization greatly affects the final molecular weight. Thus, in order to reduce the initial molecular weight, the bisulfurous acid (bisulfite) or a solution thereof is desirably added (dropped) in an amount of 5 to 20% by mass, preferably within 60 minutes of the initiation of the polymerization, more preferably within 30 minutes, and still more preferably within 10 minutes. Especially, this is effective when the polymerization is initiated at room temperature as described below.

Also, when a bisulfurous acid (bisulfite) is used as the initiator system of the components to be dropped during the polymerization, with respect to the dropping period of the bisulfurous acid (bisulfite) or a solution thereof, the end of dropping is preferably earlier than the ends of dropping of the monomers (A) and (B) by preferably 1 to 30 minutes, more preferably 1 to 20 minutes, and still more preferably 1 to 15 minutes. By this, the amount of the bisulfurous acid (bisulfite) after the polymerization can be reduced, and the generation of sulfurous acid gas and the formation of impurities caused by the bisulfurous acid (bisulfite) can be effectively and efficiently inhibited. Thus, after the polymerization, the amount of impurities which are generated when sulfurous acid gas in the gas phase dissolves into the liquid phase can be reduced significantly. When the bisulfurous acid (bisulfite) remains after the polymerization, impurities are formed, resulting in the deterioration of the properties of the polymer, precipitation of the impurities during the holding step of the polymer at a low temperature and the like. Thus, it is desirable that the initiator system including the bisulfurous acid (bisulfite) has been consumed and does not remain at the end of the polymerization.

Here, when the end of dropping of the bisulfurous acid (bisulfite) (solution) can be made earlier than the ends of dropping of the monomers (A) and (B) only by less than one minute, the bisulfurous acid (bisulfite) sometimes remains after the polymerization. Such cases include the case where dropping of the bisulfurous acid (bisulfite) or the solution thereof and dropping of the monomers (A) and (B) end simultaneously and the case where dropping of the bisulfurous acid (bisulfite) (solution) ends later than dropping of the monomers (A) and (B). In such cases, the generation of sulfurous acid gas and the formation of impurities tend to be difficult to effectively and efficiently inhibit, and the residual initiator sometimes adversely affects the thermal stability of the obtained polymer. On the other hand, when the end of dropping of the bisulfurous acid (bisulfite) or the solution thereof is earlier than the ends of dropping of the monomers (A) and (B) by more than 30 minutes, the bisulfurous acid (bisulfite) is entirely consumed before the end of the polymerization. Thus, the molecular weight tends to increase. Also, because the dropping rate of the bisulfurous acid (bisulfite) is faster than the dropping rates of the monomers (A) and (B) during the polymerization and a large amount is dropped in a short time, a large amount of impurities and a large amount of sulfurous acid gas tend to be generated during the dropping period.

When a bisulfurous acid (bisulfite) is used as the initiator system of the components to be dropped during the polymerization, the end of dropping of a persulfate (solution) is desirably later than the ends of dropping of the monomers (A) and (B) by preferably 1 to 30 minutes, more preferably 1 to 25 minutes, and still more preferably 1 to 20 minutes. By this, the amount of impurities formed due to the residual monomers can be reduced significantly: for example, the amounts of the monomer components which remain after the polymerization can be reduced.

Here, when the end of dropping of the persulfate (solution) can be made later than the ends of dropping of the monomers (A) and (B) only by less than one minute, the monomer components sometimes remain after the polymerization. Such cases include the case where dropping of the persulfate (solution) and dropping of the monomers (A) and (B) end simultaneously and the case where dropping of the persulfate (solution) ends earlier than dropping of the monomers (A) and (B). In such cases, the formation of impurities tends to be difficult to effectively and efficiently inhibit. On the other hand, when the end of dropping of the persulfate (solution) is later than the ends of dropping of the monomers (A) and (B) by more than 30 minutes, the persulfate or the decomposition product thereof remains after the polymerization, and impurities may be formed.

### (Polymerization Period)

During the polymerization, also when the polymerization temperature is low and a bisulfurous acid (bisulfite) is used as the initiator system, it is more important that the generation of sulfurous acid gas is inhibited and that the formation of impurities is prevented. Thus, the total dropping period during the polymerization is desirably long, that is, preferably 150 to 600 minutes, more preferably 160 to 450 minutes, and still more preferably 180 to 300 minutes.

When the total dropping period is shorter than 150 minutes, because the effects of the persulfate solution and the bisulfurous acid (bisulfite) solution, which are added as the initiator system, tend to deteriorate, the amount of sulfur-containing groups such as sulfonic acid groups introduced to the main chain terminals tends to decrease relative to the obtained (meth)acrylic acid-based copolymer. As a result, the weight-average molecular weight of the polymer tends to become high.

Also, because the components are dropped to the reaction system in a short time, the bisulfurous acid (bisulfite) may exist excessively. Thus, through the decomposition of such excess bisulfurous acid (bisulfite), sulfurous acid gas is sometimes generated and released from the system, and impurities are sometimes formed. However, this can be prevented by conducting the polymerization at a polymerization temperature in a specific low range using an initiator in an amount in a specific low range.

On the other hand, when the total dropping period is longer than 600 minutes, although the properties of the obtained polymer are good because the generation of sulfurous acid gas can be inhibited, the productivity decreases and the use is sometimes limited. The total dropping period here is the period from the start of dropping of the first component(s) (not necessarily one component) to the end of dropping of the last component(s) (not necessarily one component).

### (Polymerization Solid Concentration of Monomers)

When dropping of the entire amounts of the monomers, the polymerization initiator and the chain transfer agent is finished, the solid concentration (the polymerization solid concentration of the monomers, the polymerization initiator and the chain transfer agent) in the aqueous solution is preferably 35% by mass or more, more preferably 40 to 70% by mass, and still more preferably 45 to 65% by mass. When the solid concentration at the end of the polymerization reaction is 35% by mass or more, because the polymerization can be conducted at a high concentration and in one stage, a (meth)acrylic acid-based copolymer having a low molecular weight can be obtained efficiently, and the concentration step can be skipped for example. Therefore, the production efficiency and the productivity can be increased greatly, and the production cost can be kept low.

Here, when the solid concentration of the polymerization reaction system is increased, the increase in the viscosity of the reaction solution becomes remarkable as the polymerization reaction progresses, and the weight-average molecular weight of the obtained polymer tends to increase greatly. However, by conducting the polymerization reaction under acidic conditions (the range where the pH at 25° C. is one to six and the degree of neutralization of the carboxylic acid is 0 to 25% by mole), the increase in the viscosity of the reaction solution with the progress of the polymerization reaction can be inhibited. Thus, even when the polymerization reaction is conducted under a high concentration condition, a polymer having a low molecular weight can be obtained, and the production efficiency of the polymer can be improved greatly.

### (Aging Step)

In the method for producing the (meth)acrylic acid-based copolymer, after the addition of all the raw materials used is finished, an aging step may be provided for the purpose of increasing the rate of polymerization of the monomers for example. The aging period is generally 1 to 120 minutes, preferably 5 to 90 minutes, and more preferably 10 to 60 minutes. When the aging period is shorter than one minute, the monomer components sometimes remain due to insufficient aging, and impurities may be formed due to the residual monomers, resulting in the deterioration of the properties and the like. On the other hand, when the aging period is longer than 120 minutes, the polymer solution may be colored.

A preferred temperature of the polymer solution during the aging step is in the same range as that of the polymerization temperature. Thus, the temperature here may also be kept constant (preferably at the temperature at the end of dropping) or changed with time during aging.

(Step after Polymerization)

In the method for producing the (meth)acrylic acid-based copolymer, the polymerization is preferably conducted under acidic conditions as described above. Thus, the degree of neutralization of the carboxylic acid of the obtained (meth)acrylic acid-based copolymer (the final degree of neutralization of the carboxylic acid) may be set in a predetermined range after the polymerization according to need through suitable addition of a suitable alkali component as post-treatment. As the alkali component, alkali metal hydroxides such as sodium hydroxide and potassium hydroxide; alkaline earth metal hydroxides such as calcium hydroxide and magnesium hydroxide; organic amines such as ammonia, monoethanolamine, diethanolamine and triethanolamine; and the like are included.

The final degree of neutralization varies with the use and thus is not particularly limited.

Especially in the case of use as an acidic polymer, the final degree of neutralization of the carboxylic acid is preferably 0 to 75% by mole, and more preferably 0 to 70% by mole. In the case of use as a neutral or alkaline polymer, the final degree of neutralization of the carboxylic acid is preferably 75 to 100% by mole, and more preferably 85 to 99% by mole. In the case of use as a neutral or alkaline polymer, when the final degree of neutralization is more than 99% by mole, the aqueous polymer solution may be colored.

Also, when the acidic polymer is used as it is without neutralization, since the reaction system is acidic, toxic sulfurous acid gas sometimes remains in the reaction system and in the atmosphere. In such a case, the sulfurous acid gas is desirably degraded by adding a peroxide such as hydrogen peroxide or discharged by introducing (blowing) air or nitrogen gas.

In this regard, the method for producing the (meth)acrylic acid-based copolymer may be of a batch type or a continuous type.

The thus obtained (meth)acrylic acid-based copolymer can inhibit the metal corrosion in a cooling water system. The mechanism is not completely clear but is inferred as follows.

The structural unit (b) derived from the (meth)allyl ether-based monomer (B) represented by the general formula (2) interacts weakly with calcium ions and has high solubility. Thus, when the structural unit (b) is contained in an amount of 15 to 20% by mole relative to 100% by mole of the structural units derived from all the monomers, the gelation of the (meth)acrylic acid-based copolymer can be effectively prevented in a part where the flow rate is low. Also, since the (meth)acrylic acid-based copolymer used in the present invention contains a sulfonic acid group or a salt thereof at a main chain terminal, the gelation resistance of the (meth)acrylic acid-based copolymer is excellent. On the other hand, it is thought that the affinity of the carboxyl group in the structural unit (a) derived from the (meth)acrylic acid-based monomer (A) represented by the general formula (1) with a calcium ion, which is a scale component, is strong, and that the carboxyl group inhibits the growth of a calcium salt such as calcium carbonate and calcium phosphate by adhering to the growth cite of the crystal of a calcium salt such as calcium carbonate and calcium phosphate. Also, it is known that a material containing a carboxyl group has anticorrosive performance. Thus, it is thought that good anticorrosion effect can be obtained in a part where the flow rate is low by containing the structural unit (a), especially by containing the structural unit (a) in an amount of 80 to 85% by mole relative to 100% by mole of the structural units derived from all the monomers.

In addition, it is thought that when the weight-average molecular weight of the (meth)acrylic acid-based copolymer is 10,000 to 30,000, since the anticorrosion effect is excellent and the (meth)acrylic acid-based copolymer is hardly gelated, the metal corrosion in a cooling water system can be effectively inhibited.

The (meth)acrylic acid-based copolymer used in the present invention is preferably comprises a structural unit (a) derived from one, two or more (meth)acrylic acid-based monomers (A) selected from acrylic acid, methacrylic acid and sodium acrylate and a structural unit (b) derived from sodium 3-(meth)allyloxy-2-hydroxy-1-propanesulfonate, and at least one of the main chain terminal groups is a sulfonic acid group or a salt thereof.

Next, the method for treating a cooling water system of the present invention is explained.

### [Method for Treating Cooling Water System]

In the method for treating a cooling water system of the present invention, a treatment agent containing the (meth)acrylic acid-based copolymer is added to a cooling water system having the following water quality or the like, and the metal corrosion in the cooling water system is inhibited.

The (meth)acrylic acid-based copolymer is as described above but is particularly preferably a copolymer comprising a structural unit (a) derived from one, two or more (meth)acrylic acid-based monomers (A) selected from acrylic acid (AA), methacrylic acid (MAA) and sodium acrylate (SA) and a structural unit (b) derived from sodium 3-allyloxy-2-hydroxy-1-propanesulfonate (HAPS). More specifically, the (meth)acrylic acid-based copolymer is a copolymer such as AA/HAPS, MAA/HAPS, AA/SA/HAPS or AA/MAA/HAPS.

The operating conditions when the treatment method of the present invention is applied are not particularly limited.

### (Cooling Water System)

The method for treating a cooling water system of the present invention is applied to a cooling water system having a part where the calcium hardness of the cooling water is 150 to 300 mg/L and the flow rate of the cooling water is 0.3 to 0.5 m/s.

The method for adding the (meth)acrylic acid-based copolymer to such a cooling water system is not particularly limited, and the copolymer may be added to a part where the corrosion is to be prevented, a part right before the part or the like.

Also, the amount to be added is not particularly limited and can be suitably determined depending on the water quality of the cooling water system to which the copolymer is added. However, the copolymer is desirably added in such a manner that the concentration of the copolymer becomes generally 0.01 to 25 mg/L, preferably 1 to 25 mg/L, and more preferably 2 to 15 mg/L. For example, the (meth)acrylic acid-based copolymer may be added when the concentration of the copolymer in the cooling water becomes preferably less than 0.01 mg/L, more preferably less than 1 mg/L, and still more preferably less than 2 mg/L; while the addition of the (meth)acrylic acid-based copolymer may be stopped when the concentration of the copolymer in the cooling water becomes preferably more than 25 mg/L, more preferably more than 20 mg/L, and still more preferably more than 15 mg/L.

The cooling water system has a part where the flow rate is 0.3 to 0.5 m/s and may also have a part where the flow rate is outside the range. For example, the cooling water system may have a part where the flow rate is more than 0.5 m/s (for example, a part where the flow rate is more than 0.5 m/s and 2.0 m/s or less) as well as a part where the flow rate is 0.3 to 0.5 m/s. In this case, the (meth)acrylic acid-based copolymer is preferably added to the part where the flow rate is 0.3 to 0.5 m/s or a part right before the part.

The (meth)acrylic acid-based copolymer may be combined with another scale inhibitor, another anticorrosion agent and another slime controller according to need.

(Anticorrosion Agent which can be Combined)

As the anticorrosion agent which can be combined, for example, phosphonic acids such as hydroxyethylidene diphosphonic acid, phosphonobutanetricarboxylic acid, ethylenediamine tetramethylene phosphonic acid and nitrilotrimethyl phosphonic acid, orthophosphoric acid salts, polymeric phosphoric acid salts, phosphate esters, zinc salts, nickel salts, molybdenum salts, tungsten salts, oxycarboxylic acid salts, triazoles, amines and the like can be included.

(Scale Inhibitor which can be Combined)

As the scale inhibitor which can be combined, for example, phosphonic acids such as hydroxyethylidene diphosphonic acid, phosphonobutanetricarboxylic acid, ethylenediamine tetramethylene phosphonic acid and nitrilotrimethyl phosphonic acid, orthophosphoric acid salts, polymeric phosphoric acid salts, polymaleic acid, polyacrylic acid, maleic acid copolymers, copolymers of maleic acid/acrylic acid, maleic acid/isobutylene, maleic acid/sulfonic acid, acrylic acid/sulfonic acid and acrylic acid/nonionic group-containing monomer, terpolymers such as acrylic acid/sulfonic acid/nonionic group-containing monomer and the like can be included.

As the sulfonic acid, for example, vinylsulfonic acid, allylsulfonic acid, styrenesulfonic acid, isoprenesulfonic acid, 3-allyloxy-2-hydroxypropanesulfonic acid, 2-acrylamido-2-methylpropanesulfonic acid, 2-methacrylamido-2-methylpropanesulfonic acid, 4-sulfobutyl methacrylate, allyloxybenzenesulfonic acid, methallyloxybenzenesulfonic acid and metal salts thereof can be included.

As the nonionic group-containing monomer, for example, alkylamides (alkylamides having an alkyl group with one to five carbon atoms), hydroxyethyl methacrylate, mono(meth)acrylate of (poly)ethylene/propylene oxide with a number of moles of addition of 1 to 30, monovinylether ethylene/propylene oxide with a number of moles of addition of 1 to 30 and the like can be included.

(Slime Controller which can be Combined)

The slime controller which can be combined may be a slime controller containing for example, a quaternary ammonium salt such as alkyldimethylbenzyl ammonium chloride, chlormethyl trithiazoline, chlormethyl isothiazoline, methylisothiazoline, ethylamino isopropylamino methyl thiatriazine, hypochlorous acid, hypobromous acid, a mixture of hypochlorous acid and sulfamic acid, an enzyme, a germicide, a colorant, a fragrance, a water-soluble organic solvent, a defoaming agent or the like.

A kind of each of the scale inhibitor, the anticorrosion agent and the slime controller may be used alone, or a combination of two or more kinds thereof may be used.

### EXAMPLES

The present invention is described in more detail below by reference to Examples, but it should be construed that the present invention is not limited by these Examples at all.

An anticorrosion test was conducted by the following method, and at the same time, by the following methods, the weight-average molecular weights of the copolymers were measured, and it was determined whether or not there were terminal sulfonic groups.

### (1) Anticorrosion Test (Pitting Corrosion Test)

Water obtained by dechlorinating tap water of Nogi-machi, Shimotsuga-gunnshi, Tochigi, Japan was put into a 50-L plastic container in an amount calculated by subtracting the amounts of the respective reagents to be added from 50 L. As the reagents, an aqueous sodium hydrogen carbonate solution, an aqueous sodium silicate solution, a polymer solution (a solution of one of the (meth)acrylic acid-based copolymers described below), an aqueous magnesium sulfate solution, an aqueous sodium chloride solution, a phosphoric acid solution, an aqueous calcium chloride solution and an aqueous zinc sulfate solution were added, and the pH was then adjusted with small amounts of an aqueous sodium hydroxide solution and an aqueous sulfuric acid solution. Test water samples with the water type A or the water type B shown in Table 1 were thus prepared.

A test water sample (50 L) was kept at 30° C. and caused to flow in an evaluation tube (carbon steel, an inside diameter of 15 mm, an outside diameter of 19 mm, a length of 100 mm, and a surface area of 47 cm²) at a flow rate of 0.3 m/s or 0.9 m/s, and the test water sample was continuously supplied in such a manner that the residence time became 120 hours. After two weeks, the evaluation tube was collected, cut in half and air-dried, and the depth of the pitting corrosion was measured by the following procedure.

The pitting corrosion parts on the inner surface of the evaluation tube were all measured, and the maximum depth was regarded as the pitting corrosion depth in the anticorrosion test. The results of the anticorrosion test were evaluated as follows.

A: The pitting corrosion depth was 0.1 mm or less.

B: The pitting corrosion depth was more than 0.1 mm and 0.2 mm or less.

C: The pitting corrosion depth was more than 0.2 mm and 0.3 mm or less.

D: The pitting corrosion depth was more than 0.3 mm.

TABLE 1

| Item | | Water type A | Water type B |
|---|---|---|---|
| pH | — | 8.4 | 8.8 |
| M alkalinity | mg/L as CaCO₃ | 150 | 300 |
| Calcium hardness | mg/L as CaCO₃ | 150 | 300 |
| Magnesium hardness | mg/L as CaCO₃ | 75 | 150 |
| Silica | mg/L as SiO₂ | 15 | 30 |
| Total phosphoric acid | mg/L as PO₄ | 4 | 4 |
| Zinc ion | mg/L as Zn | 2 | 2 |
| Polymer | mg/L as Solid | 5 | 5 |

### (2) Measurement of Weight-Average Molecular Weight of Copolymer

The weight-average molecular weight of each of the (meth)acrylic acid-based copolymers was measured under the following conditions using gel permeation chromatography (“HLC-8320GPC” manufactured by Tosoh Corporation).

Detector: RI

Column: Shodex Asahipak GF-310-HQ, GF-710-HQ and GF-1G manufactured by Showa Denko K.K.

Eluent: 0.1 N aqueous sodium acetate solution

Flow rate: 0.5 ml/min

Column temperature: 40° C.

Calibration curve: POLYACRYLIC ACID STANDARD (manufactured by Sowa Science Corporation)

### (3) Confirmation of Presence or Absence of Terminal Sulfonic Acid Group in Copolymer

A copolymer (an aqueous solution) adjusted to pH1 was dried at room temperature at reduced pressure to distill the water off, and then ¹H-NMR measurement was conducted using heavy water as the solvent. It was determined whether or not a sulfonic acid group was introduced to a main chain terminal of the copolymer by the presence or absence of the peak at 2.7 ppm derived from the sulfonic acid group.

### Examples 1 to 3 and Comparative Examples 1 to 7

(Meth)acrylic acid-based copolymer solutions (polymer solutions) were obtained by polymerizing acrylic acid (AA) and sodium 3-allyloxy-2-hydroxy-1-propanesulfonate (HAPS) at the ratios shown in Table 2. Table 2 shows the weight-average molecular weights of the copolymers and shows whether or not terminal sulfonic acid groups were introduced.

The anticorrosion test (pitting corrosion test) was conducted using the copolymers, and the results were as shown in Table 2.

TABLE 2

| | | | | | | Anticorrosion test | | | |
|---|---|---|---|---|---|---|---|---|---|
| | (Meth)acrylic acid-based copolymer | | | | | corrosion rate (mdd) | | | |
| | | | | Weight | | Water | | Water | |
| | | Monomer | | average | Terminal | type A | | type B | |
| | | (mol %) | | molecular | sulfonic | Flow rate (m/s) | | | |
| | Structure | AA | HAPS | weight | acid group | 0.3 | 0.9 | 0.3 | 0.9 |
| Example 1 | AA/HAPS | 82 | 18 | 10,500 | Introduced | B | A | B | A |
| Example 2 | AA/HAPS | 82 | 18 | 20,000 | Introduced | B | A | B | A |
| Example 3 | AA/HAPS | 82 | 18 | 28,000 | Introduced | B | A | B | A |
| Comparative | AA | 100 | — | 3,500 | — | C | B | C | B |
| Example 1 | | | | | | | | | |
| Comparative | AA/HAPS | 90 | 10 | 9,500 | Introduced | B | A | C | B |
| Example 2 | | | | | | | | | |
| Comparative | AA/HAPS | 72 | 28 | 17,000 | Introduced | D | C | C | B |
| Example 3 | | | | | | | | | |
| Comparative | AA/HAPS | 82 | 18 | 8,500 | Introduced | D | C | C | B |
| Example 4 | | | | | | | | | |
| Comparative | AA/HAPS | 82 | 18 | 5,500 | Introduced | D | C | C | B |
| Example 5 | | | | | | | | | |
| Comparative | AA/HAPS | 82 | 18 | 56,500 | Introduced | D | C | C | B |
| Example 6 | | | | | | | | | |
| Comparative | AA/HAPS | 82 | 18 | 10,000 | Not | D | C | B | B |
| Example 7 | | | | | introduced | | | | |

AA: acrylic acid
HAPS: sodium 3-allyloxy-2-hydroxy-1-propanesulfonate

When Examples 1 to 3 and Comparative Examples 1 to 7 are compared, it can be seen that Examples 1 to 3 had excellent anticorrosion effect (effect of inhibiting the pitting corrosion) under both of the water type conditions of the water types A and B and also on both of the part with a low flow rate and the part with a high flow rate.

When Examples 1 to 3 and Comparative Example 3 are compared, it can be seen that the (meth)acrylic copolymers of Examples 1 to 3, which each had a content of the structural unit (b) of 15% by mole to 20% by mole relative to 100% by mole of the structural units derived from all the monomers, had superior effect of inhibiting the pitting corrosion to that of the (meth)acrylic copolymer of Comparative Example 3, which had a content of the structural unit (b) of 28% by mole.

When Examples 1 to 3 and Comparative Examples 4 to 6 are compared, it can be seen that the (meth)acrylic copolymers of Examples 1 to 3, which each had a weight-average molecular weight of 10,000 to 30,000, had superior effect of inhibiting the pitting corrosion to that of the (meth)acrylic copolymers of Comparative Examples 4 to 6, which each had a weight-average molecular weight that was outside the range.

When Examples 1 to 3 and Comparative Example 7 are compared, it can be seen that the (meth)acrylic copolymers of Examples 1 to 3, in which at least one of the main chain terminal groups was a sulfonic acid group or a salt thereof, had superior effect of inhibiting the pitting corrosion to that of the (meth)acrylic copolymer of Comparative Example 7, in which the main chain terminal groups were not a sulfonic acid group or a salt thereof.

### INDUSTRIAL APPLICABILITY

By the method for treating a cooling water system of the present invention, the metal corrosion of the heat transfer surfaces of a heat exchanger, a pipe and the like in a cooling water system using water with low calcium hardness and a low flow rate can be prevented effectively without adding a chemical agent with a high concentration.

1. A method for treating a cooling water system, which comprises adding a (meth)acrylic acid-based copolymer to a cooling water system comprising a part where the calcium hardness of cooling water is 150 to 300 mg/L and the flow rate of the cooling water is 0.3 to 0.5 m/s,
wherein the (meth)acrylic acid-based copolymer comprises a structural unit (a) derived from a (meth)acrylic acid-based monomer (A) represented by the following general formula (1) and a structural unit (b) derived from a (meth)allyl ether-based monomer (B) represented by the following general formula (2),
the content of the structural unit (b) is 15% by mole to 20% by mole relative to 100% by mole of the structural units derived from all the monomers,
the weight-average molecular weight of the (meth)acrylic acid-based copolymer is 10,000 to 30,000, and
at least one of the main chain terminal groups of the (meth)acrylic acid-based copolymer is a sulfonic acid group or a salt thereof: 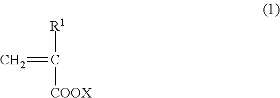
wherein R¹ represents a hydrogen atom or a methyl group, and X represents a hydrogen atom, a metal atom, an ammonium group or an organic amine; 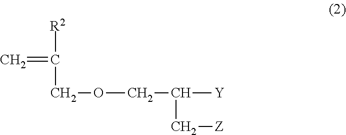
wherein R² represents a hydrogen atom or a methyl group, Y and Z each independently represent a hydroxyl group, a sulfonic acid group or a salt thereof, and at least one of Y and Z represents a sulfonic acid group or a salt thereof.

2. The method for treating a cooling water system according to claim 1, wherein the (meth)acrylic acid-based copolymer comprises a structural unit (a) derived from one, two or more (meth)acrylic acid-based monomers (A) selected from acrylic acid, methacrylic acid and sodium acrylate and a structural unit (b) derived from sodium 3-(meth)allyloxy-2-hydroxy-1-propanesulfonate.

3. The method for treating a cooling water system according to claim 1, wherein the (meth)acrylic acid-based copolymer is added to the cooling water system in a manner that the concentration of the (meth)acrylic acid-based copolymer in the cooling water becomes 0.01 to 25 mg/L.
